(19) United States
(12) Patent Application Publication
(10) Pub. No.: US 2024/0056980 A1
(43) Pub. Date: Feb. 15, 2024

(54) Enhancement of PUCCH Transmissions

(71) Applicant: Apple Inc., Cupertino, CA (US)

(72) Inventors: Haitong SUN, Cupertino, CA (US); Chunxuan YE, San Diego, CA (US); Dawei ZHANG, Saratoga, CA (US); Hong HE, San Jose, CA (US); Huaning NIU, San Jose, CA (US); Oghenekome OTERI, San Diego, CA (US); Seyed Ali Akbar FAKOORIAN, San Diego, CA (US); Wei ZENG, Saratoga, CA (US); Weidong YANG, San Diego, CA (US); Yushu ZHANG, Beijing (CN)

(21) Appl. No.: 17/754,546

(22) PCT Filed: Apr. 6, 2021
(86) PCT No.: PCT/CN2021/085594

§ 371 Date: Apr. 5, 2022

(51) Int. Cl. H04W 52/14

(52) U.S. Cl. CPC H04W 52/146

(57) ABSTRACT

A user equipment (UE) is configured to transmit physical uplink control channel (PUCCH) or physical uplink shared channel (PUSCH) transmissions. The UE receives a downlink control information (DCI) transmission including a transmission power control (TPC) configuration, wherein the TPC configuration includes at least one TPC command, determines a subset of (i) multiple closed loop indexes or (ii) multiple beams for which the TPC command is configured, wherein the multiple closed loop indexes and multiple beams correspond to multiple transmission and reception points (TRPs) and applies the TPC command to one or more physical uplink control channel (PUCCH) or physical uplink shared channel (PUSCH) transmissions corresponding to the subset of multiple closed loop indexes or beams.

### BACKGROUND

In 5G new radio (NR) wireless communications, the 5G NR network may utilize multi-transmission and reception points (TRP) to improve reliability of the wireless channels. For example, multiple physical uplink control channel (PUCCH) transmissions (e.g., two PUSCHs) and/or multiple physical uplink shared channel (PUSCH) transmissions may be scheduled for a user equipment (UE) transmission via multi-TRPs to improve the throughput of the UE.

### SUMMARY

Some exemplary embodiments are related to a processor of a user equipment (UE) configured to perform operations. The operations include receiving a downlink control information (DCI) transmission including a transmission power control (TPC) configuration, wherein the TPC configuration includes at least one TPC command, determining a subset of (i) multiple closed loop indexes or (ii) multiple beams for which the TPC command is configured, wherein the multiple closed loop indexes and multiple beams correspond to multiple transmission and reception points (TRPs) and applying the TPC command to one or more physical uplink control channel (PUCCH) or physical uplink shared channel (PUSCH) transmissions corresponding to the subset of multiple closed loop indexes or beams.

Other exemplary embodiments are related to a processor of a user equipment (UE) configured to perform operations. The operations include receiving an enhanced physical uplink control channel (PUCCH) repetition configuration and transmitting a PUCCH transmission with a configured number of repetitions based on the PUCCH repetition configuration.

Still further exemplary embodiments are related to a processor of a base station configured to perform operations. The operations include transmitting, to a user equipment (UE), a downlink control information (DCI) transmission including a transmission power control (TPC) configuration, wherein the TPC configuration includes at least one TPC command, wherein the UE is configured to determine a subset of (i) multiple closed loop indexes or (ii) multiple beams for which the TPC command is configured, wherein the multiple closed loop indexes and multiple beams correspond to multiple transmission and reception points (TRPs), and wherein the UE is configured to apply the TPC command to one or more physical uplink control channel (PUCCH) or physical uplink shared channel (PUSCH) transmissions corresponding to the subset of multiple closed loop indexes or beams.

Additional exemplary embodiments are related to a processor of a base station configured to perform operations. The operations include transmitting an enhanced physical uplink control channel (PUCCH) repetition configuration to a user equipment (UE) and transmitting a PUCCH transmission with a configured number of repetitions based on the PUCCH repetition configuration to the UE.

### BRIEF DESCRIPTION OF THE DRAWINGS

FIG. 1 shows an exemplary network arrangement according to various exemplary embodiments.

FIG. 2 shows an exemplary UE according to various exemplary embodiments.

FIG. 3 shows an exemplary base station according to various exemplary embodiments.

FIG. 4 shows a diagram illustrating an exemplary UE communicating with multiple transmission and reception points (TRPs) according to various exemplary embodiments.

FIG. 5 shows a method of configuring a closed loop power control (CLPC) for physical uplink control channel (PUCCH) and physical uplink shared channel (PUSCH) transmissions corresponding to multiple TRPs according to various exemplary embodiments.

FIGS. 6A-6C show diagrams illustrating the application of a TPC to PUCCH/PUSCH transmissions corresponding to multiple TRPs according to various exemplary embodiments.

FIG. 7 shows a method of dynamically configuring a PUCCH repetition according to various exemplary embodiments.

FIG. 8 shows an exemplary enhanced DL-DataToUL-ACK table with PUCCH repetitions according to various exemplary embodiments.

### DETAILED DESCRIPTION

The exemplary embodiments may be further understood with reference to the following description and the related appended drawings, wherein like elements are provided with the same reference numerals. The exemplary embodiments relate to a user equipment (UE) receiving closed loop power control (CLPC) configuration for physical uplink control channel (PUCCH) and physical uplink shared channel (PUSCH) transmissions for multi-transmission and reception point (TRP) operation. The exemplary embodiments further relate to a UE receiving a dynamic configuration of PUCCH repetitions. The exemplary embodiments still further relate to a UE receiving a configuration of sub-slot based PUCCH repetitions.

The exemplary embodiments are described with regard to a UE. However, reference to a UE is merely provided for illustrative purposes. The exemplary embodiments may be utilized with any electronic component that may establish a connection to a network and is configured with the hardware, software, and/or firmware to exchange information and data with the network. Therefore, the UE as described herein is used to represent any appropriate electronic component.

In addition, the exemplary embodiments are described with regard to a 5G New Radio (NR) network. However, reference to a 5G NR network is merely provided for illustrative purposes. The exemplary embodiments may be utilized with any network that implements the functionalities described herein.

A next generation NodeB (gNB) of a 5G NR network configures a closed loop power control (CLPC) for a UE's transmission of PUSCH and PUCCH transmissions. In a downlink control information (DCI) transmission for downlink (e.g., DCI Format 1_0, 1_1, 1_2), the gNB indicates a transmission power control (TPC) to be applied to a PUCCH transmission. In a DCI transmission for uplink (e.g., DCI Format 00, 01, 02), the gNB indicates a TPC to be applied to a PUSCH transmission. However, the current 3GPP standards do not address the configuration of a TPC for PUCCH/PUSCH repetitions corresponding to multiple TRPs in multi-TRP operation.

According to the exemplary embodiments, an enhanced CLPC indication is provided, where the gNB configures a TPC for PUCCH/PUSCH repetitions when either different closed loop indexes or beams are configured for corresponding different TRPs of a multi-TRP system.

Presently, there is no dynamic indication of PUCCH repetitions. According to further exemplary embodiments, the gNB may dynamically configure the UE with a number PUCCH repetitions to advantageously provide a faster indication of the number of PUCCH repetitions.

Current 3GPP standards do not support sub-slot based PUCCH repetitions. According to still further exemplary embodiments, the gNB may configure the UE with sub-slot based PUCCH repetitions to advantageously increase reliability and improve latency of the PUCCH transmissions.

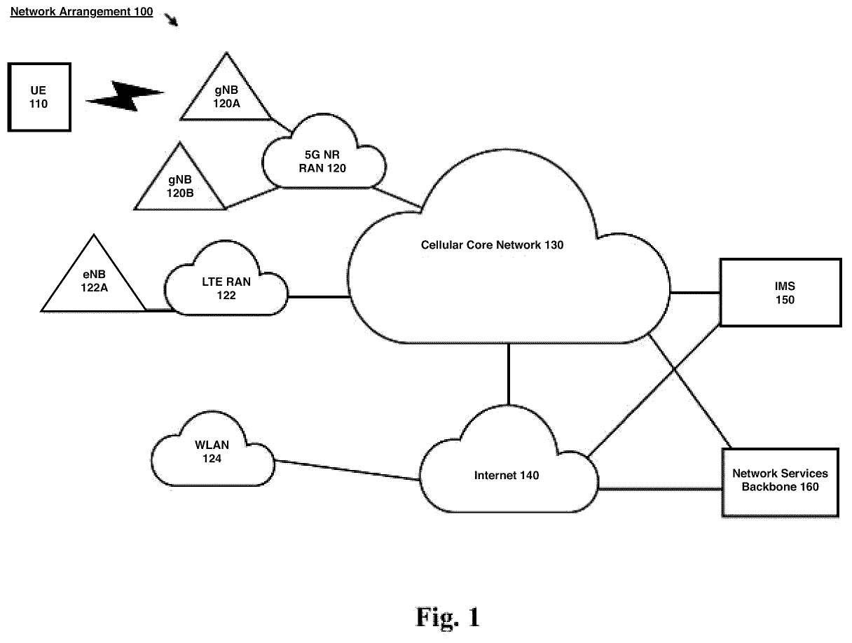

FIG. 1 shows an exemplary network arrangement 100 according to various exemplary embodiments. The exemplary network arrangement 100 includes a UE 110. It should be noted that any number of UE may be used in the network arrangement 100. Those skilled in the art will understand that the UE 110 may be any type of electronic component that is configured to communicate via a network, e.g., mobile phones, tablet computers, desktop computers, smartphones, phablets, embedded devices, wearables, Internet of Things (IoT) devices, etc. It should also be understood that an actual network arrangement may include any number of UEs being used by any number of users. Thus, the example of a single UE 110 is merely provided for illustrative purposes.

The UE 110 may be configured to communicate with one or more networks. In the example of the network configuration 100, the networks with which the UE 110 may wirelessly communicate are a 5G New Radio (NR) radio access network (5G NR-RAN) 120, an LTE radio access network (LTE-RAN) 122 and a wireless local access network (WLAN) 124. However, it should be understood that the UE 110 may also communicate with other types of networks and the UE 110 may also communicate with networks over a wired connection. Therefore, the UE 110 may include a 5G NR chipset to communicate with the 5G NR-RAN 120, an LTE chipset to communicate with the LTE-RAN 122 and an ISM chipset to communicate with the WLAN 124.

The 5G NR-RAN 120 and the LTE-RAN 122 may be portions of cellular networks that may be deployed by cellular providers (e.g., Verizon, AT&T, T-Mobile, etc.). These networks 120, 122 may include, for example, cells or base stations (Node Bs, eNodeBs, HeNBs, eNBS, gNBs, gNodeBs, macrocells, microcells, small cells, femtocells, etc.) that are configured to send and receive traffic from UE that are equipped with the appropriate cellular chip set. The WLAN 124 may include any type of wireless local area network (WiFi, Hot Spot, IEEE 802.11x networks, etc.).

The UE 110 may connect to the 5G NR-RAN 120 via the gNB 120A and/or the gNB 120B. The gNBs 120A and 120B may be configured with the necessary hardware (e.g., antenna array), software and/or firmware to perform massive multiple in multiple out (MIMO) functionality. Massive MIMO may refer to a base station that is configured to generate a plurality of beams for a plurality of UE. During operation, the UE 110 may be within range of a plurality of gNBs. Reference to two gNBs 120A, 120B is merely for illustrative purposes. The exemplary embodiments may apply to any appropriate number of gNBs. Further, the UE 110 may communicate with the eNB 122A of the LTE-RAN 122 to transmit and receive control information used for downlink and/or uplink synchronization with respect to the 5G NR-RAN 120 connection.

Those skilled in the art will understand that any association procedure may be performed for the UE 110 to connect to the 5G NR-RAN 120. For example, as discussed above, the 5G NR-RAN 120 may be associated with a particular cellular provider where the UE 110 and/or the user thereof has a contract and credential information (e.g., stored on a SIM card). Upon detecting the presence of the 5G NR-RAN 120, the UE 110 may transmit the corresponding credential information to associate with the 5G NR-RAN 120. More specifically, the UE 110 may associate with a specific base station (e.g., the gNB 120A of the 5G NR-RAN 120).

In addition to the networks 120, 122 and 124 the network arrangement 100 also includes a cellular core network 130, the Internet 140, an IP Multimedia Subsystem (IMS) 150, and a network services backbone 160. The cellular core network 130 may be considered to be the interconnected set of components that manages the operation and traffic of the cellular network. The cellular core network 130 also manages the traffic that flows between the cellular network and the Internet 140. The IMS 150 may be generally described as an architecture for delivering multimedia services to the UE 110 using the IP protocol. The IMS 150 may communicate with the cellular core network 130 and the Internet 140 to provide the multimedia services to the UE 110. The network services backbone 160 is in communication either directly or indirectly with the Internet 140 and the cellular core network 130. The network services backbone 160 may be generally described as a set of components (e.g., servers, network storage arrangements, etc.) that implement a suite of services that may be used to extend the functionalities of the UE 110 in communication with the various networks.

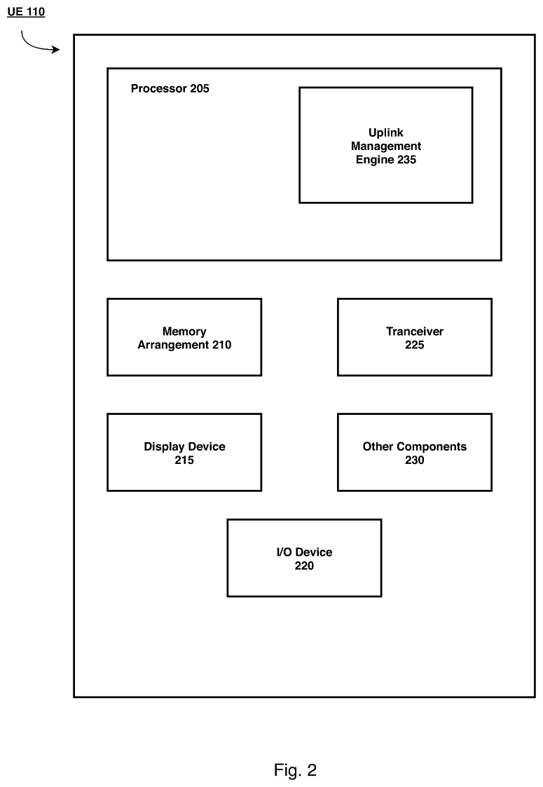

FIG. 2 shows an exemplary UE 110 according to various exemplary embodiments. The UE 110 will be described with regard to the network arrangement 100 of FIG. 1. The UE 110 may represent any electronic device and may include a processor 205, a memory arrangement 210, a display device 215, an input/output (I/O) device 220, a transceiver 225 and other components 230. The other components 230 may include, for example, an audio input device, an audio output device, a battery that provides a limited power supply, a data acquisition device, ports to electrically connect the UE 110 to other electronic devices, one or more antenna panels, etc. For example, the UE 110 may be coupled to an industrial device via one or more ports.

The processor 205 may be configured to execute a plurality of engines of the UE 110. For example, the engines may include an uplink management engine 235. The uplink management engine 235 may perform various operations related to receiving and applying configurations for PUCCH and PUSCH transmissions, as will be described in greater detail below.

The above referenced engine being an application (e.g., a program) executed by the processor 205 is only exemplary. The functionality associated with the engine may also be represented as a separate incorporated component of the UE 110 or may be a modular component coupled to the UE 110, e.g., an integrated circuit with or without firmware. For example, the integrated circuit may include input circuitry to receive signals and processing circuitry to process the signals and other information. The engines may also be embodied as one application or separate applications. In addition, in some UE, the functionality described for the processor 205 is split among two or more processors such as a baseband processor and an applications processor. The exemplary embodiments may be implemented in any of these or other configurations of a UE.

The memory arrangement 210 may be a hardware component configured to store data related to operations performed by the UE 110. The display device 215 may be a hardware component configured to show data to a user while the I/O device 220 may be a hardware component that enables the user to enter inputs. The display device 215 and the I/O device 220 may be separate components or integrated together such as a touchscreen. The transceiver 225 may be a hardware component configured to establish a connection with the 5G NR-RAN 120, the LTE-RAN 122, the WLAN 124, etc. Accordingly, the transceiver 225 may operate on a variety of different frequencies or channels (e.g., set of consecutive frequencies).

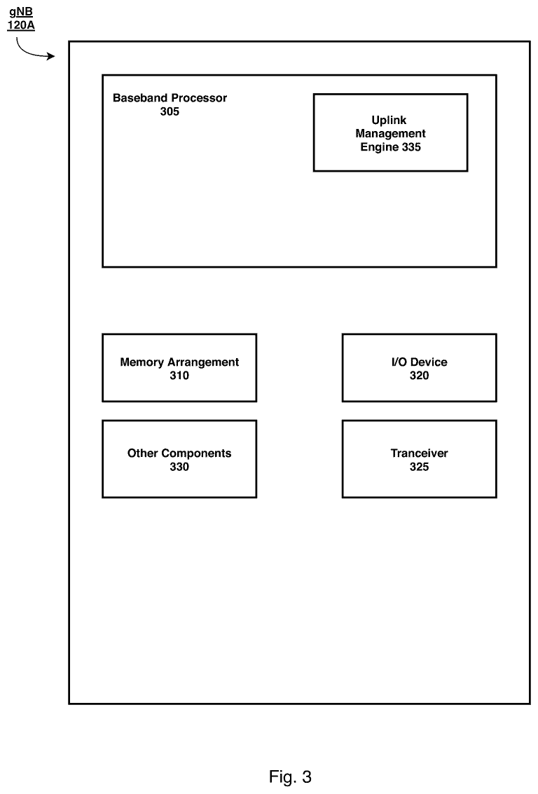

FIG. 3 shows an exemplary network cell, in this case gNB 120A, according to various exemplary embodiments. The gNB 120A may represent any access node of the 5G NR network through which the UEs 110 may establish a connection. The gNB 120A illustrated in FIG. 3 may also represent the gNB 120B.

The gNB 120A may include a processor 305, a memory arrangement 310, an input/output (I/O) device 320, a transceiver 325, and other components 330. The other components 330 may include, for example, a power supply, a data acquisition device, ports to electrically connect the gNB 120A to other electronic devices, etc.

The processor 305 may be configured to execute a plurality of engines of the gNB 120A. For example, the engines may include uplink management engine 335 for performing operations including configuring PUCCH and PUSCH transmissions for a UE. Examples of this process will be described in greater detail below.

The above noted engine being an application (e.g., a program) executed by the processor 305 is only exemplary. The functionality associated with the engines may also be represented as a separate incorporated component of the gNB 120A or may be a modular component coupled to the gNB 120A, e.g., an integrated circuit with or without firmware. For example, the integrated circuit may include input circuitry to receive signals and processing circuitry to process the signals and other information. In addition, in some gNBs, the functionality described for the processor 305 is split among a plurality of processors (e.g., a baseband processor, an applications processor, etc.). The exemplary aspects may be implemented in any of these or other configurations of a gNB.

The memory 310 may be a hardware component configured to store data related to operations performed by the UEs 110, 112. The I/O device 320 may be a hardware component or ports that enable a user to interact with the gNB 120A. The transceiver 325 may be a hardware component configured to exchange data with the UE 110 and any other UE in the system 100. The transceiver 325 may operate on a variety of different frequencies or channels (e.g., set of consecutive frequencies). Therefore, the transceiver 325 may include one or more components (e.g., radios) to enable the data exchange with the various networks and UEs.

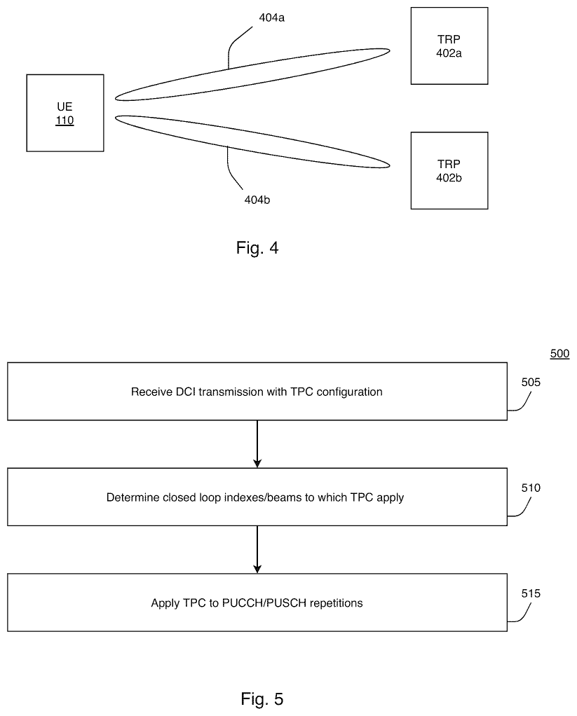

FIG. 4 shows a diagram illustrating an exemplary UE 110 communicating with multiple TRPs 402a, 402b according to various exemplary embodiments. It should be noted that although FIG. 4 illustrates two (2) TRPs, any reference to two (2) TRPs with regards to FIG. 4 or in the following description is only exemplary and the network 100 may include any number of TRPs. As illustrated in FIG. 4, the UE 110 may communicate with a first TRP 402a via a first beam 404a and with a second TRP 402b over a second beam 404b. Each TRP 402a, 402b is associated with a closed loop index (e.g., 0, 1). In some embodiments, the UE 110 maintains two closed loop indexes (configured by the gNB 120A or 120B) corresponding to the two TRPs 402a,b for each component carrier (CC). It should be noted that although the first and second TRPs 402a, 402b are illustrated as two distinct and separate entities, the first and second TRPs 402a, 402b may be two antenna panels at the same location. In addition, each TRP may also have multiple antenna panels. In such a scenario, there may be a corresponding beam between the UE 110 and each antenna panel.

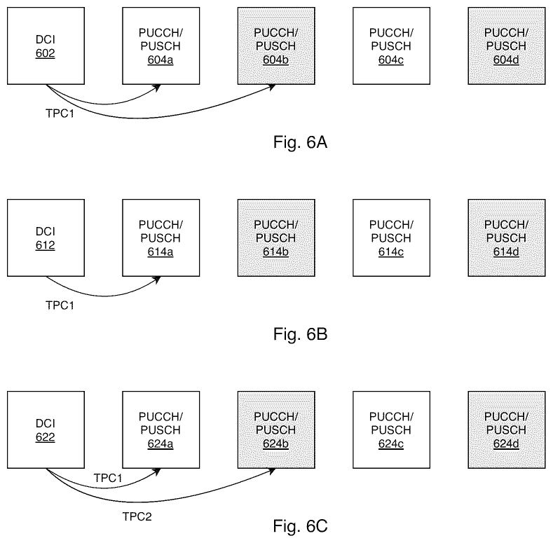

FIG. 5 shows a method 500 of determining a transmission power control (TPC) for PUCCH and PUSCH transmissions corresponding to multiple TRPs (e.g., 402a, b) according to various exemplary embodiments. In the method 500, it may be considered that each PUCCH/PUSCH is configured with a different closed loop index corresponding to a different TRP or with a different beam corresponding to a different TRP and/or antenna panel. The following description will also make reference to FIGS. 6A-6C, which show diagrams illustrating the application of a TPC to PUCCH/PUSCH transmissions corresponding to multiple TRPs according to various exemplary embodiments.

At 505, the UE 110 receives a DCI transmission (602, 612, or 622) indicating a TPC to be applied to one or more PUCCH or PUSCH repetitions. The TPC field of the DCI includes a TPC command, which instructs the UE 110 to increase or decrease the transmission power. In the case of PUCCH transmissions, the DCI transmission may be a DCI Format 1_0, 1_1, or 1_2 transmission. In the case of PUSCH transmissions, the DCI transmission may be a DCI Format 0_0, 0_1, or 0_2 transmission.

At 510, the UE 110 determines a subset of multiple closed loop indexes or multiple beams to which the TPC command applies. Each closed loop index and/or beam corresponds to one TRP of a multi-TRP system. As will be explained below, the subset may include one closed loop index or beam or multiple closed loop indexes or beams.

In some exemplary embodiments, a DCI 602 indicates one TPC (TPC1) which is configured to be applied to both closed loop indexes (corresponding to both TRPs 402a,b) or both beams (e.g., 404a,b), as illustrated in FIG. 6A. In these exemplary embodiments, the UE 110 applies the TPC indicated in the DCI 602 to PUCCH/PUSCH transmissions 604a-d corresponding to both TRPs 402a,b. In the diagrams of FIGS. 6A-6C, the shaded PUCCH/PUSCH transmissions correspond to a first TRP and the non-shaded PUCCH/PUSCH transmissions correspond to a second TRP.

In some exemplary embodiments, a DCI 612 may indicate one TPC (TPC1) which is configured to be applied to only one closed loop index or beam. This one closed loop index or beam may be the first or the second closed loop index or beam. The DCI may indicate to which one closed loop index or beam the TPC command applies. As illustrated in the example shown in FIG. 6B, the TPC of the DCI 612 is applied to the first one of the PUCCH/PUSCH transmissions 614a-d. That is, the TPC command is applied to the first closed loop index or beam.

In some exemplary embodiments, a DCI 612 may indicate a first TPC (TPC1) and may include a second TPC field that indicates a second TPC (TPC2). Each TPC command is mapped to a different closed loop index or beam. As illustrated in FIG. 6C, the first TPC is applied to a first PUCCH/PUSCH transmission 624a (as well as a third PUCCH/PUSCH transmission 624c although not explicitly indicated) and the second TPC is applied to a second PUCCH/PUSCH transmission 624b (as well as a fourth PUCCH/PUSCH transmission 624d although not explicitly indicated). As such, the DCI 622 configures a different TPC for each TRP.

In some exemplary embodiments, the UE 110 maintains one CLPC for each closed loop index (for each TRP/antenna panel). In other exemplary embodiments, there are multiple closed loop indexes that correspond multiple TRPs and/or antenna panels. In some exemplary embodiments, the UE 110 may maintain a CLPC for each beam (indicated by spatial relation information) or group of beams. In such a scenario, each group of beams has one closed loop index (corresponding to a TRP/antenna panel). In other exemplary embodiments, the UE 110 may maintain a CLPC for per group of beams and per closed loop index. In such a scenario, multiple closed loop indexes may be dynamically indicated (configured by gNB 120A or 120B) for each group of beams. However, the UE 110 may maintain a separate closed loop index for each pair of (i) the group of beams and (ii) the closed loop index. As a result, the UE 110 may advantageously maintain multiple closed loop indexes corresponding to multiple TRPs and multiple antenna panels.

In some exemplary embodiments, the DCI that configures the CLPC is a group DCI (DCI Format 2_2) that controls the TPC for multiple UEs. In the group DCI, both closed loop indicators (0 and 1) may be modified in the same block of the DCI. If the UE 110 is not configured with “twoPUSCH-PC-AdjustmentStates” or “twoPUCCH-PC-AdjustmentStates” (single TRP operation), then each block includes two (2) bits, which control the TPC for transmissions to the single TRP. However, if the UE 110 is configured with “twoPUSCH-PC-AdjustmentStates” or “twoPUCCH-PC-AdjustmentStates” (multi-TRP), each block contains four (4) bits, with the first two bits corresponding to CLPC index 0 (a first TRP) and the second two bits corresponding to CLPC index 1 (a second TRP).

In some exemplary embodiments, the group DCI may configure the CLPC independently per group of beams. In each block, the TPC command may be configured for different groups of beams. For example, each group of beams may include a beam group indicator with a corresponding TPC command mapped to that beam group indicator. As such, each block may include multiple TPCs corresponding to the multiple groups of beams. In some exemplary embodiments, multiple TPCs may be concatenated and mapped to all beam groups if no beam group indicator exists. In such an embodiment, each segment of the concatenated TPC (e.g., 2 bits) is mapped to a corresponding beam group.

Returning to FIG. 5, at 515, the UE 110 applies the TPC(s) indicated in the DCI to the PUCCH/PUSCH transmission(s) corresponding to the subset of multiple closed loop indexes or multiples beams.

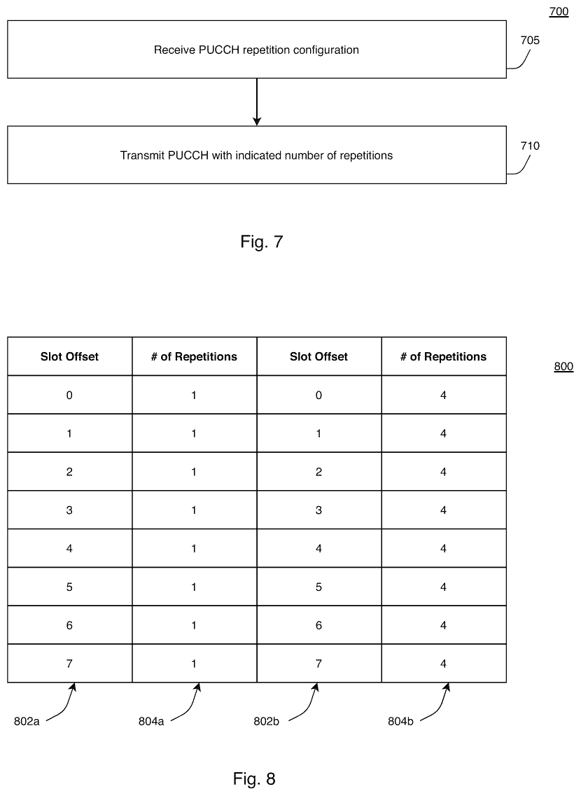

FIG. 7 shows a method 700 of dynamically configuring a PUCCH repetition according to various exemplary embodiments. At 705, the UE 110 receives a PUCCH repetition configuration from the gNB 120A (or 120B). In some exemplary embodiments, the PUCCH repetition configuration may be performed via a radio resource control (RRC) configuration. In these exemplary embodiments, in each “PUCCH-FormatConfig” in “PUCCH-Config” of the RRC, a list of “nrofSlots” is configured. The number of repetitions may then be indicated by a DCI which selects one of the entries of the “nrofSlots” list. In other exemplary embodiments, the PUCCH repetition configuration may be performed directly via a DCI. In these exemplary embodiments, the DCI may include an additional field or an existing field bitwidth may be increased to explicitly indicate the number of PUCCH repetitions.

In some exemplary embodiments, the “PDSCH-to-HARQ feedback timing indicator” field of a DCI may select a slot offset (k1) and a corresponding number of repetitions from a “DL-DataToUL-ACK” table 800 (FIG. 8). As shown in FIG. 8, the DL-DataToUL-ACK” table 800 includes two columns 802a, 802b corresponding to slot offset values and two columns 804a, 804b corresponding to a number of repetitions. For example, if the value “PDSCH-to-HARQ_feedback timing indicator” field of the DCI is 02, then the slot offset between the PDSCH and the HARQ-ACK is 2 and the number of PUCCH repetitions is 1. It should be noted that although the table 800 shows 8 rows, the size of the table may have any number of rows.

Returning to FIG. 7, at 710, the UE 110 transmits the PUCCH with the number of repetitions indicated in the PUCCH repetitions configuration, as discussed above.

In some exemplary embodiments, the UE 110 does not handle both a legacy PUCCH repetition configuration (configured via “nrofSlots” in RRC) and one of the PUCCH repetition configurations discussed above (hereinafter “enhanced PUCCH repetition configuration”). In some exemplary embodiments, if both legacy and enhanced PUCCH repetitions are configured, then the UE 110 may process the enhanced PUCCH repetition configuration and disregard the legacy PUCCH repetition configuration. In some exemplary embodiments, if both legacy and enhanced PUCCH repetitions are configured, then the UE 110 may process the legacy PUCCH repetition configuration and disregard the enhanced PUCCH repetition configuration.

In some exemplary embodiments, the enhanced PUCCH repetition configuration may include a sub-slot based PUCCH repetition configuration. The sub-slots may include two 7-symbol sub-slots or seven 2-symbol sub-slots. In some exemplary embodiments, the relative time/frequency domain resource allocation across the sub-slots is the same. For example, for time domain, the transmission may always begin from a predetermined starting symbol in each sub-slot. Frequency hopping may also be prohibited. In some exemplary embodiments, a PUCCH repetition may be transmitted in different sub-slots either consecutively or non-consecutively. For example, a PUCCH transmission may be transmitted in non-consecutive sub-slots to avoid possible collision with downlink symbols. In some exemplary embodiments, frequency hopping may be allowed for different sub-slots, e.g., the frequency domain resource allocation for different sub-slots may be different.

In some exemplary embodiments, if sub-slot based PUCCH repetitions are configured, no PUCCH transmissions may cross sub-slot boundaries. In some exemplary embodiments, PUCCH transmission may cross sub-slot boundaries. In such an embodiment, the UE 110 transmits the PUCCH repetitions irrespective of the fact the one or more of the transmissions cross a sub-slot boundary. In some exemplary embodiments, the UE 110 may cancel the entire transmission(s) that crosses a sub-slot boundary. In other exemplary embodiments, the UE 110 may truncate a PUCCH transmission that crosses a sub-slot boundary at the boundary. For example, if a four symbol PUCCH transmission has the first two symbols in a first sub-slot and the second two symbols in a second sub-slot, the UE 110 may cancel the second two symbols. In some exemplary embodiments, the UE 110 may split a PUCCH transmission at the slot boundary into two transmissions. For example, in the above example, the UE 110 may split the PUCCH transmission into a first PUCCH transmission in the first sub-slot and a second PUCCH transmission in the second sub-slot.

In some exemplary embodiments, the UE 110 may be configured with sub-slot based PUCCH repetitions via RRC. In these exemplary embodiments, if the “subslotLengthForPUCCH” field of the “PUCCH-Config” of the RRC message is configured, then the UE 110 transmits sub-slot based PUCCH repetitions. If the “subslotLengthForPUCCH” field is not configured, then the UE 110 transmits slot-based PUCCH repetitions. In some exemplary embodiments, a medium access control (MAC) control element (CE) may be configured to indicate a “subslotLengthForPUCCH” field or may simply activate or deactivate sub-slot based PUCCH repetitions. In some exemplary embodiments, a DCI may provide the sub-slot or slot based PUCCH repetitions indication. In these exemplary embodiments, the DCI may include a new field that explicitly indicates whether the PUCCH repetitions are sub-slot based or slot based. In other exemplary embodiments, the “DL-DataToUL-ACK” table 800 (FIG. 8) may include an additional column indicating whether the indicated number of repetitions is sub-slot or slot based. As a result, the “PDSCH-to-HARQ_feedback timing indicator” codepoint would indicate the slot offset, number of repetitions, and whether the repetitions are sub-slot based or slot based.

### EXAMPLES

In a first example, a user equipment (UE) comprises a transceiver configured to communicate with a network, and a processor communicatively coupled to the transceiver and configured to perform operations comprising receiving a downlink control information (DCI) transmission including a transmission power control (TPC) configuration, wherein the TPC configuration includes at least one TPC command, determining a subset of (i) multiple closed loop indexes or (ii) multiple beams for which the TPC command is configured, wherein the multiple closed loop indexes and multiple beams correspond to multiple transmission and reception points (TRPs), applying the TPC command to one or more physical uplink control channel (PUCCH) or physical uplink shared channel (PUSCH) transmissions corresponding to the subset of multiple closed loop indexes or beams.

In a second example, the UE of the first example, wherein the at least one TPC command is a single TPC command, and wherein the subset includes all of the multiple closed loop indexes or multiple beams.

In a third example, the UE of the first example, wherein the at least one TPC command is a single TPC command, and wherein the subset includes one of the multiple closed loop indexes or multiple beams.

In a fourth example, the UE of the first example, wherein the at least one TPC command includes multiple TPC commands corresponding to the multiple closed loop indexes or multiple beams, each TPC command corresponding to one of the multiple closes loop indexes or multiple beams, and wherein the subset includes all of the multiple closed loop indexes or multiple beams.

In a fifth example, the UE of the first example, wherein the operations further comprise maintaining one closed loop power control (CLPC) for each of the multiple closed loop indexes.

In a sixth example, the UE of the first example, wherein the operations further comprise maintaining one CLPC for each of the multiple beams or a group of beams.

In a seventh example, the UE of the first example, wherein the operations further comprise maintaining one CLPC for each of the multiple closed loop indexes, maintaining one CLPC for each of the multiple beams or a group of beams, and maintaining one CLPC for each closed loop index and beam or beam group pair.

In an eighth example, the UE of the first example, wherein the DCI transmission is a group DCI transmission including at least one block corresponding to a plurality of UEs, and wherein if the UE is not configured a “twoPUSCH-PC-AdjustmentStates” field or a “twoPUCCH-PC-AdjustmentStates,” the at least one block includes two bits corresponding to a single closed loop index.

In a ninth example, the UE of the first example, wherein the DCI transmission is a group DCI transmission including at least one block corresponding to a plurality of UEs, and wherein if the UE is configured a “twoPUSCH-PC-AdjustmentStates” field or a “twoPUCCH-PC-AdjustmentStates,” the at least one block includes four bits, two of which correspond to a first closed loop index and another two of which correspond to a second closed loop index.

In a tenth example, the UE of the first example, wherein the DCI transmission is a group DCI transmission including at least one block corresponding to a plurality of UEs, and wherein the at least one block includes multiple TPC commands, each of which is configured for a corresponding group of beams or closed loop index.

In an eleventh example, a user equipment (UE) comprises a transceiver configured to communicate with a network, and a processor communicatively coupled to the transceiver and configured to perform operations comprising receiving an enhanced physical uplink control channel (PUCCH) repetition configuration, and transmitting a PUCCH transmission with a configured number of repetitions based on the PUCCH repetition configuration.

In a twelfth example, the UE of the eleventh example, wherein the enhanced PUCCH repetition configuration comprises a radio resource configuration (RRC) transmission including an “nrofSlots” list that contains multiple entries of repetitions, and a downlink control information (DCI) transmission indicating which of the multiple entries should be the configured number of repetitions.

In a thirteenth example, the UE of the eleventh example, wherein the enhanced PUCCH repetition configuration comprises a DCI transmission having a field which explicitly indicates the configured number of repetitions.

In a fourteenth example, the UE of the eleventh example, wherein the enhanced PUCCH repetition configuration comprises a DCI transmission having an extended bitwidth field which explicitly indicates the configured number of repetitions in addition to an additional indication.

In a fifteenth example, the UE of the eleventh example, wherein the enhanced PUCCH repetition configuration comprises a DCI transmission having a “PDSCH-to-HARQ_feedback timing indicator” field that indicates one of multiple entries of a “DL-DataToUL-ACK” table, wherein each of the multiple entries indicates (i) a slot offset between a physical downlink shared channel (PDSCH) transmission and a hybrid automatic repeat request acknowledgement (HARQ-ACK), and (ii) the configured number of repetitions.

In a sixteenth example, the UE of the eleventh example, wherein when the UE is configured with a legacy PUCCH repetition configuration and the enhanced PUCCH repetition configuration, the operations further comprise disregarding the legacy PUCCH repetition configuration and the enhanced PUCCH repetition configuration.

In a seventeenth example, the UE of the eleventh example, wherein when the UE is configured with a legacy PUCCH repetition configuration and the enhanced PUCCH repetition configuration, the operations further comprise disregarding the legacy PUCCH repetition configuration.

In an eighteenth example, the UE of the eleventh example, wherein when the UE is configured with a legacy PUCCH repetition configuration and the enhanced PUCCH repetition configuration, the operations further comprise disregarding the enhanced PUCCH repetition configuration.

In a nineteenth example, the UE of the eleventh example, wherein the enhanced PUCCH repetition configuration is a sub-slot based PUCCH repetition configuration.

In a twentieth example, the UE of the nineteenth example, wherein a relative time domain resource allocation and a relative frequency domain resource allocation are the same among sub-slots.

In a twenty-first example, the UE of the nineteenth example, wherein the sub-slot based PUCCH repetition configuration configures PUCCH repetitions across different sub-slots in a consecutive or non-consecutive pattern.

In a twenty-second example, the UE of the nineteenth example, wherein the sub-slot based PUCCH repetition configuration configures different frequency domain resources for different sub-slots.

In a twenty-third example, the UE of the nineteenth example, wherein the sub-slot based PUCCH repetition configuration does not configure any PUCCH repetitions across sub-slot boundaries.

In a twenty-fourth example, the UE of the nineteenth example, wherein the sub-slot based PUCCH repetition configuration configures one or more PUCCH repetitions across sub-slot boundaries.

In a twenty-fifth example, the UE of the twenty-fourth example, wherein the operations further comprise disregarding the one or more PUCCH repetitions that cross sub-slot boundaries.

In a twenty-sixth example, the UE of the twenty-fourth example, wherein the operations further comprise truncating each of the one or more PUCCH repetitions that cross sub-slot boundaries at the sub-slot boundaries.

In a twenty-seventh example, the UE of the twenty-fourth example, wherein the operations further comprise segmenting each of the one or more PUCCH repetitions that cross sub-slot boundaries at the sub-slot boundaries to create two or more PUCCH repetitions.

In a twenty-eighth example, the UE of the eleventh example, wherein the enhanced PUCCH repetition configuration includes an indication of whether the PUCCH repetitions are slot based PUCCH repetitions or sub-slot based PUCCH repetitions.

In a twenty-ninth example, the UE of the twenty-eighth example, wherein the indication is contained in a “PUCCH-Config” field of an RRC transmission, and wherein when a “subslotLengthForPUCCH” field is configured in the “PUCCH-Config” field, the PUCCH repetitions are sub-slot based PUCCH repetitions, and when the “subslotLengthForPUCCH” field is not configured in the “PUCCH-Config” field, the PUCCH repetitions are slot based PUCCH repetitions.

In a thirtieth example, the UE of the twenty-eighth example, wherein the indication is contained in a MAC CE, and wherein when a “subslotLengthForPUCCH” is configured in the MAC CE, the PUCCH repetitions are sub-slot based PUCCH repetitions.

In a thirty-first example, the UE of the twenty-eighth example, wherein the indication is explicitly provided in a MAC CE.

In a thirty-second example, the UE of the twenty-eighth example, wherein the indication is explicitly provided in a DCI transmission having a “PDSCH-to-HARQ_feedback timing indicator” field that indicates one of multiple entries of a “DL-DataToUL-ACK” table, wherein each of the multiple entries indicates (i) a slot offset between a physical downlink shared channel (PDSCH) transmission and a hybrid automatic repeat request acknowledgement (HARQ-ACK), (ii) the configured number of repetitions, and (iii) whether the PUCCH repetitions are slot based or sub-slot based.

In a thirty-third example, the UE of the twenty-eighth example, wherein the indication is explicitly provided in a DCI transmission.

In a thirty-fourth example, a base station comprises a transceiver configured to communicate with a user equipment (UE), and a processor communicatively coupled to the transceiver and configured to perform operations comprising transmitting a downlink control information (DCI) transmission including a transmission power control (TPC) configuration, wherein the TPC configuration includes at least one TPC command, wherein the UE determines a subset of (i) multiple closed loop indexes or (ii) multiple beams for which the TPC command is configured, wherein the multiple closed loop indexes and multiple beams correspond to multiple transmission and reception points (TRPs), and wherein the UE applies the TPC command to one or more physical uplink control channel (PUCCH) or physical uplink shared channel (PUSCH) transmissions corresponding to the subset of multiple closed loop indexes or beams.

In a thirty-fifth example, the base station of the thirty-fourth example, wherein the at least one TPC command is a single TPC command, and wherein the subset includes all of the multiple closed loop indexes or multiple beams.

In a thirty-sixth example, the base station of the thirty-fourth example, wherein the at least one TPC command is a single TPC command, and wherein the subset includes one of the multiple closed loop indexes or multiple beams.

In a thirty-seventh example, the base station of the thirty-fourth example, wherein the at least one TPC command includes multiple TPC commands corresponding to the multiple closed loop indexes or multiple beams, each TPC command corresponding to one of the multiple closes loop indexes or multiple beams, and wherein the subset includes all of the multiple closed loop indexes or multiple beams.

In a thirty-eighth example, the base station of the thirty-fourth example, wherein the operations further comprise maintaining one closed loop power control (CLPC) for each of the multiple closed loop indexes.

In a thirty-ninth example, the base station of the thirty-fourth example, wherein the operations further comprise maintaining one CLPC for each of the multiple beams or a group of beams.

In a fortieth example, the base station of the thirty-fourth example, wherein the operations further comprise maintaining one CLPC for each of the multiple closed loop indexes, maintaining one CLPC for each of the multiple beams or a group of beams, and maintaining one CLPC for each closed loop index and beam or beam group pair.

In a forty-first example, the base station of the thirty-fourth example, wherein the DCI transmission is a group DCI transmission including at least one block corresponding to a plurality of UEs, and wherein if the UE is not configured a “twoPUSCH-PC-AdjustmentStates” field or a “twoPUCCH-PC-AdjustmentStates,” the at least one block includes two bits corresponding to a single closed loop index.

In a forty-second example, the base station of the thirty-fourth example, wherein the DCI transmission is a group DCI transmission including at least one block corresponding to a plurality of UEs, and wherein if the UE is configured a “twoPUSCH-PC-AdjustmentStates” field or a “twoPUCCH-PC-AdjustmentStates,” the at least one block includes four bits, two of which correspond to a first closed loop index and another two of which correspond to a second closed loop index.

In a forty-third example, the base station of the thirty-fourth example, wherein the DCI transmission is a group DCI transmission including at least one block corresponding to a plurality of UEs, and wherein the at least one block includes multiple TPC commands, each of which is configured for a corresponding group of beams or closed loop index.

In a forty-fourth example, a base station comprises a transceiver configured to communicate with a user equipment (UE), and a processor communicatively coupled to the transceiver and configured to perform operations comprising transmitting an enhanced physical uplink control channel (PUCCH) repetition configuration, and receiving a PUCCH transmission with a configured number of repetitions based on the PUCCH repetition configuration.

In a forty-fifth example, the base station of the forty-fourth example, wherein the enhanced PUCCH repetition configuration comprises a radio resource configuration (RRC) transmission including an “nrofSlots” list that contains multiple entries of repetitions, and a downlink control information (DCI) transmission indicating which of the multiple entries should be the configured number of repetitions.

In a forty-sixth example, the base station of the forty-fourth example, wherein the enhanced PUCCH repetition configuration comprises a DCI transmission having a field which explicitly indicates the configured number of repetitions.

In a forty-seventh example, the base station of the forty-fourth example, wherein the enhanced PUCCH repetition configuration comprises a DCI transmission having an extended bitwidth field which explicitly indicates the configured number of repetitions in addition to an additional indication.

In a forty-eighth example, the base station of the forty-fourth example, wherein the enhanced PUCCH repetition configuration comprises a DCI transmission having a “PDSCH-to-HARQ_feedback timing indicator” field that indicates one of multiple entries of a “DL-DataToUL-ACK” table, wherein each of the multiple entries indicates (i) a slot offset between a physical downlink shared channel (PDSCH) transmission and a hybrid automatic repeat request acknowledgement (HARQ-ACK), and (ii) the configured number of repetitions.

In a forty-ninth example, the base station of the forty-fourth example, wherein when the UE is configured with a legacy PUCCH repetition configuration and the enhanced PUCCH repetition configuration, the UE is configured to disregard the legacy PUCCH repetition configuration and the enhanced PUCCH repetition configuration.

In a fiftieth example, the base station of the forty-fourth example, wherein when the UE is configured with a legacy PUCCH repetition configuration and the enhanced PUCCH repetition configuration, the UE is configured to disregard the legacy PUCCH repetition configuration.

In a fifty-first example, the base station of the forty-fourth example, wherein when the UE is configured with a legacy PUCCH repetition configuration and the enhanced PUCCH repetition configuration, the UE is configured to disregard the enhanced PUCCH repetition configuration.

In a fifty-second example, the base station of the forty-fourth example, wherein the enhanced PUCCH repetition configuration is a sub-slot based PUCCH repetition configuration.

In a fifty-third example, the base station of the fifty-second example, wherein a relative time domain resource allocation and a relative frequency domain resource allocation are the same among sub-slots.

In a fifty-fourth example, the base station of the fifty-second example, wherein the sub-slot based PUCCH repetition configuration configures PUCCH repetitions across different sub-slots in a consecutive or non-consecutive pattern.

In a fifty-fifth example, the base station of the fifty-second example, wherein the sub-slot based PUCCH repetition configuration configures different frequency domain resources for different sub-slots.

In a fifty-sixth example, the base station of the fifty-second example, wherein the sub-slot based PUCCH repetition configuration does not configure any PUCCH repetitions across sub-slot boundaries.

In a fifty-seventh example, the base station of the fifty-second example, wherein the sub-slot based PUCCH repetition configuration configures one or more PUCCH repetitions across sub-slot boundaries.

In a fifty-eighth example, the base station of the fifty-seventh example, wherein the UE is configured to disregard the one or more PUCCH repetitions that cross sub-slot boundaries.

In a fifty-ninth example, the base station of the fifty-seventh example, wherein the UE is configured to truncate each of the one or more PUCCH repetitions that cross sub-slot boundaries at the sub-slot boundaries.

In a sixtieth example, the base station of the fifty-seventh example, wherein the UE is configured to segment each of the one or more PUCCH repetitions that cross sub-slot boundaries at the sub-slot boundaries to create two or more PUCCH repetitions.

In a sixty-first example, the base station of the forty-fourth example, wherein the enhanced PUCCH repetition configuration includes an indication of whether the PUCCH repetitions are slot based PUCCH repetitions or sub-slot based PUCCH repetitions.

In a sixty-second example, the base station of the sixty-first example, wherein the indication is contained in a “PUCCH-Config” field of an RRC transmission, and wherein when a “subslotLengthForPUCCH” field is configured in the “PUCCH-Config” field, the PUCCH repetitions are sub-slot based PUCCH repetitions, and when the “subslotLengthForPUCCH” field is not configured in the “PUCCH-Config” field, the PUCCH repetitions are slot based PUCCH repetitions.

In a sixty-third example, the base station of the sixty-first example, wherein the indication is contained in a MAC CE, and wherein when a “subslotLengthForPUCCH” is configured in the MAC CE, the PUCCH repetitions are sub-slot based PUCCH repetitions.

In a sixty-fourth example, the base station of the sixty-first example, wherein the indication is explicitly provided in a MAC CE.

In a sixty-fifth example, the base station of the sixty-first example, wherein the indication is explicitly provided in a DCI transmission having a “PDSCH-to-HARQ_feedback timing indicator” field that indicates one of multiple entries of a “DL-DataToUL-ACK” table, wherein each of the multiple entries indicates (i) a slot offset between a physical downlink shared channel (PDSCH) transmission and a hybrid automatic repeat request acknowledgement (HARQ-ACK), (ii) the configured number of repetitions, and (iii) whether the PUCCH repetitions are slot based or sub-slot based.

In a thirty-sixth example, the base station of the sixty-first example, wherein the indication is explicitly provided in a DCI transmission.

Those skilled in the art will understand that the above-described exemplary embodiments may be implemented in any suitable software or hardware configuration or combination thereof. An exemplary hardware platform for implementing the exemplary embodiments may include, for example, an Intel x86 based platform with compatible operating system, a Windows OS, a Mac platform and MAC OS, a mobile device having an operating system such as iOS, Android, etc. The exemplary embodiments of the above-described method may be embodied as a program containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

1. A processor of a user equipment (UE) configured to perform operations comprising:
receiving a downlink control information (DCI) transmission including a transmission power control (TPC) configuration, wherein the TPC configuration includes at least one TPC command;
determining a subset of (i) multiple closed loop indexes or (ii) multiple beams for which the TPC command is configured, wherein the multiple closed loop indexes and multiple beams correspond to multiple transmission and reception points (TRPs); and
applying the TPC command to one or more physical uplink control channel (PUCCH) or physical uplink shared channel (PUCCH) transmissions corresponding to the subset of multiple closed loop indexes or beams.

2. The processor of claim 1, wherein the at least one TPC command is a single TPC command, and wherein the subset includes all of the multiple closed loop indexes or multiple beams.

3. The processor of claim 1, wherein the at least one TPC command is a single TPC command, and wherein the subset includes one of the multiple closed loop indexes or multiple beams.

4. The processor of claim 1, wherein the at least one TPC command includes multiple TPC commands corresponding to the multiple closed loop indexes or multiple beams, each TPC command corresponding to one of the multiple closes loop indexes or multiple beams, and wherein the subset includes all of the multiple closed loop indexes or multiple beams.

5. The processor of claim 1, wherein the operations further comprise:
maintaining one closed loop power control (CLPC) for each of the multiple closed loop indexes.

6. The processor of claim 1, wherein the operations further comprise:
maintaining one CLPC for each of the multiple beams or a group of beams.

7. The processor of claim 1, wherein the operations further comprise:
maintaining one CLPC for each of the multiple closed loop indexes;
maintaining one CLPC for each of the multiple beams or a group of beams; and
maintaining one CLPC for each closed loop index and beam or beam group pair.

8. A processor of a user equipment (UE) configured to perform operations comprising:
receiving an enhanced physical uplink control channel (PUCCH) repetition configuration; and
transmitting a PUCCH transmission with a configured number of repetitions based on the PUCCH repetition configuration.

9. The processor of claim 8, wherein the enhanced PUCCH repetition configuration comprises:
a radio resource configuration (RRC) transmission including an “nrofSlots” list that contains multiple entries of repetitions; and
a downlink control information (DCI) transmission indicating which of the multiple entries should be the configured number of repetitions.

10. The processor of claim 8, wherein the enhanced PUCCH repetition configuration comprises:
a DCI transmission having a field which explicitly indicates the configured number of repetitions.

11. The processor of claim 8, wherein the enhanced PUCCH repetition configuration comprises:
a DCI transmission having an extended bitwidth field which explicitly indicates the configured number of repetitions in addition to an additional indication.

12. The processor of claim 8, wherein the enhanced PUCCH repetition configuration comprises:
a DCI transmission having a “PDSCH-to-HARQ_feedback timing indicator” field that indicates one of multiple entries of a “DL-DataToUL-ACK” table, wherein each of the multiple entries indicates (i) a slot offset between a physical downlink shared channel (PDSCH) transmission and a hybrid automatic repeat request acknowledgement (HARQ-ACK), and (ii) the configured number of repetitions.

13. A processor of a base station configured to perform operations comprising:
transmitting, to a user equipment (UE), a downlink control information (DCI) transmission including a transmission power control (TPC) configuration, wherein the TPC configuration includes at least one TPC command,
wherein the UE is configured to determine a subset of (i) multiple closed loop indexes or (ii) multiple beams for which the TPC command is configured, wherein the multiple closed loop indexes and multiple beams correspond to multiple transmission and reception points (TRPs), and
wherein the UE is configured to apply the TPC command to one or more physical uplink control channel (PUCCH) or physical uplink shared channel (PUSCH) transmissions corresponding to the subset of multiple closed loop indexes or beams.

14. The processor of claim 13, wherein the at least one TPC command is a single TPC command, and wherein the subset includes all of the multiple closed loop indexes or multiple beams.

15. The processor of claim 13, wherein the at least one TPC command is a single TPC command, and wherein the subset includes one of the multiple closed loop indexes or multiple beams.

16. The processor of claim 13, wherein the at least one TPC command includes multiple TPC commands corresponding to the multiple closed loop indexes or multiple beams, each TPC command corresponding to one of the multiple closes loop indexes or multiple beams, and wherein the subset includes all of the multiple closed loop indexes or multiple beams.

17. The processor of claim 13, wherein the UE is configured to maintain one closed loop power control (CLPC) for each of the multiple closed loop indexes.

18. The processor of claim 13, wherein the UE is configured to maintain one CLPC for each of the multiple beams or a group of beams.

19. The processor of claim 13, wherein the UE is configured to:
maintain one CLPC for each of the multiple closed loop indexes;
maintain one CLPC for each of the multiple beams or a group of beams; and
maintain one CLPC for each closed loop index and beam or beam group pair.

20-24. (canceled)
